(19) United States
(12) Patent Application Publication
(10) Pub. No.: US 2002/0104794 A1
(43) Pub. Date: Aug. 8, 2002

(54) Filter apparatus using alternate types of replaceable filter elements

(76) Inventor: Jack E. Hoffmann, Oostburg, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 09/777,948

(22) Filed: Feb. 6, 2001

(51) Int. Cl. C02F 1/00

(52) U.S. Cl. 210/323.2

(57) ABSTRACT

The end cap or header for a water filter apparatus using replaceable tubular filter elements includes a central sealing sleeve that extends downwardly from the underside of the header within the threaded boss providing connection to the filter housing, the sealing sleeve adapted to provide sealing engagement with either of two common types of filter elements, one utilizing an annular end seal and the other utilizing an O-ring seal on the filter element delivery tube.

### BACKGROUND OF THE INVENTION

The present invention pertains to a water filter apparatus of the type utilizing replaceable filter elements and, more particularly, to a filter apparatus adapted to use different types of replaceable filter elements having fundamentally different types of seals without altering the construction of the apparatus.

Drinking water filter systems for home use and similar applications have long been made with replaceable filter elements commonly having a cylindrical tubular shape defining a hollow axial interior. The element is usually contained in an open-ended housing or sump and is enclosed therein by a demountable end cap or a header element where the flow of incoming raw water and outgoing filtered water is directed and controlled. Incoming raw water is typically directed from the end cap or header into the housing and around the outside of the filter element, radially through the element where the impurities are removed, into the hollow center of the element and axially out of the open end of the element and back into the header for discharge as purified filtered water. The filter apparatus may be operated in the reverse direction from that just described.

The replaceable filter element may include any of a variety of filter materials and media, including mechanical separation materials such as filter paper or cloth, fibers, or particulate materials, both natural and synthetic; materials that provide multiple removal functions such as filtering and absorption, e.g. activated carbon; ion exchange media; and reverse osmosis membranes. However, many of the foregoing media, when incorporated into replaceable filter elements, utilize one of two types of sealing elements to separate the inlet and outlet flows of water being treated. Thus, the replaceable filter element may include a bottom end seal that engages the bottom inside of the filter housing, and a top end seal that engages a cover or header to which the housing is demountably attached, as with a threaded connection. Two types of top end filter element seals are most common and are dictated largely by the construction and function of the filter element. These include an annular seal element mounted on the top of the upper end of the filter element surrounding the open end. The other type of sealing element is used with filter elements that include a cylindrical delivery tube extending axially from the open upper end of the filter element. The delivery tube is typically provided with a pair of axially spaced O-ring seals seated in annular grooves, which seals cooperate with the mating cylindrical I.D. of a tubular element extending downwardly from the underside of the cover or header, the tubular element commonly referred to as a standpipe. The standpipe also functions as a pilot or centering device for the open end of the filter element as the housing and element are attached to the header. Adaptation of a filter apparatus to a construction utilizing one of the two types of sealing elements described above typically requires the use of a different type of cover or header construction. Further, filter elements utilizing an axially extending delivery tube that is received within and seals against the interior of the standpipe cause a reduction in the area of the outlet flow path and a resultant increase in pressure drop.

It would be most desirable, therefore, to have a filter apparatus adapted to use interchangeably filter elements having either of the two basic seal element constructions and in which flow into or through the standpipe, if used, is not restricted.

### SUMMARY OF THE INVENTION

In accordance with the present invention, a filter apparatus provides the adaptability to use either of (1) a first cylindrical tubular filter element of the type having an annular seal element that surrounds and is mounted on one open end or (2) a second cylindrical tubular filter element of the type having a cylindrical delivery tube that extends axially from one open end of the filter element and carries on its outer cylindrical surface an O-ring seal arrangement, the filter apparatus comprising a housing having an open end adapted to receive either of said filter elements inserted axially into the open end, a header element providing a closure for the housing and the filter element, said header element having a demountable connector for cooperative attachment to the housing, and a downwardly depending cylindrical sleeve on the header element which is axially aligned with the filter element in the housing, the sleeve having a free edge to sealingly engage the annular seal element of the first filter element in response to attachment of the header to the housing, and the cylindrical sleeve also having a cylindrical inner wall alternately adapted to receive the delivery tube of a second filter element and to sealingly engage the O-ring seal arrangement in response to attachment of the header to the housing.

The filter apparatus of the present invention is adaptable to utilize filter element constructions which include an annular end cap on the end of the filter element. In one such filter element, the annular seal comprises a ring-shaped seal of generally rectangular cross-section which is mounted on the end cap. In the other of the standard filter elements, the delivery tube comprises an integral extension of the end cap. In such a filter element, the O-ring seal arrangement may comprise a pair of axially spaced O-rings which are seated in annular grooves in the outer cylindrical surface of the delivery tube for sealing engagement with the cylindrical inner wall of the cylindrical sleeve on the header.

In the second type of filter element utilizing a delivery tube, the tube may comprise an integral extension of a product water tube which defines the tubular interior of the element and extends substantially the full axial length thereof. As with the version of the filter element in which the delivery tube comprises an integral extension of the end cap, the delivery tube which is an axial extension of a product water tube may also carry a pair of axially spaced O-rings that are seated in annular grooves in the outer cylindrical surface thereof.

In any of the embodiments of the filter elements described above, the filter apparatus may include a header element having a conventional tubular center standpipe that is positioned inside and concentric with the cylindrical sealing sleeve. The standpipe extends axially into the tubular interior of the filter element in response to connection of the header for end cap to the housing.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a side elevation view showing the general arrangement of a three-element filter system of the present invention.

FIG. 2 is an enlarged sectional detail of the apparatus shown in FIG. 1 using a first type of filter element and showing details of the sealing interface.

FIG. 3 is an enlarged sectional detail of another part of the filter apparatus shown in FIG. 1 showing details of a second filter element and the sealing interface.

FIG. 4 is a further enlarged detail of a portion of FIG. 3 defined generally by the line 4-4 in FIG. 3.

FIG. 5 is an exploded perspective view of the filter apparatus shown in FIG. 1 disclosing details of the filter elements which the filter system of the present invention is adapted to use.

### DETAILED DESCRIPTION OF THE PREFERRED EMBODIMENT

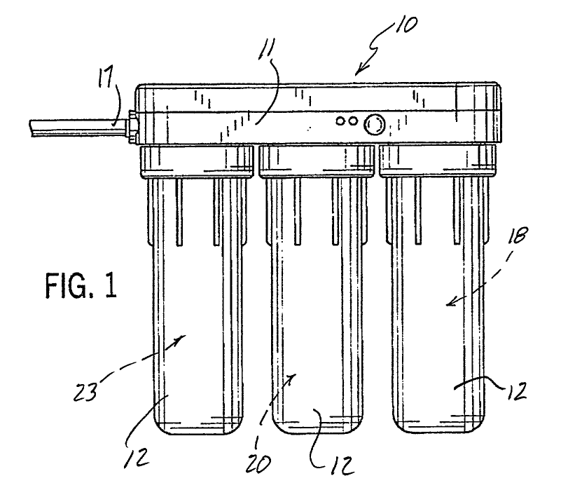

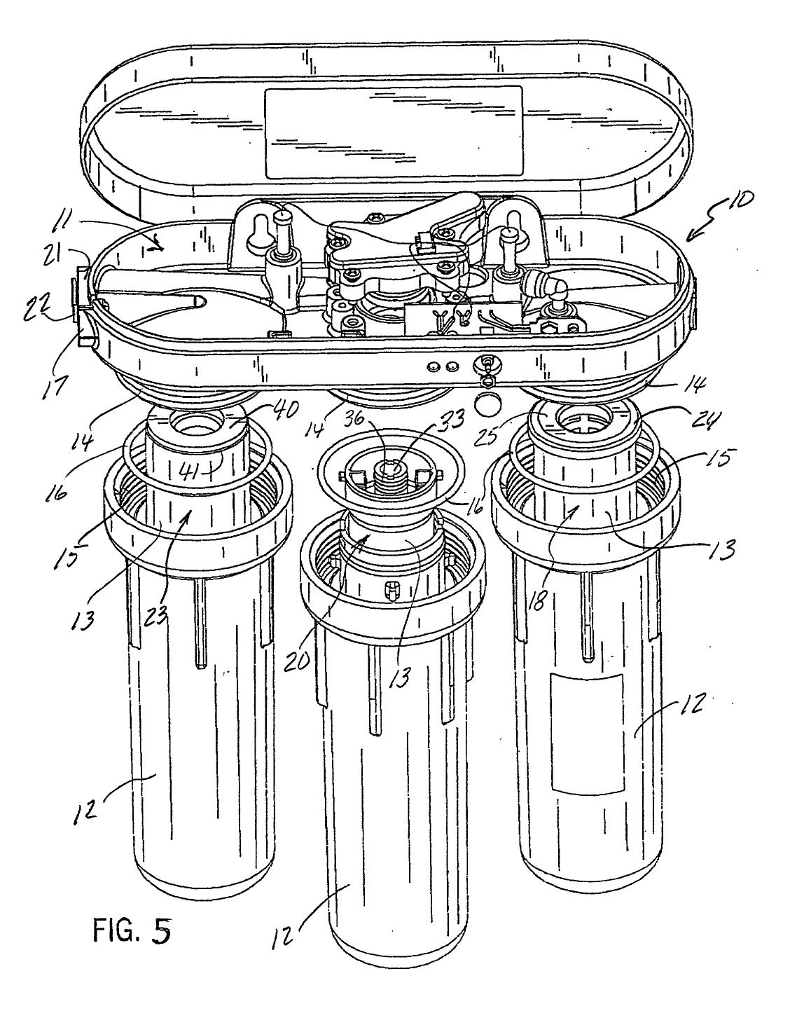

Referring initially to FIGS. 1 and 5, there is shown a filter apparatus 10 of a type utilizing three series connected filter elements intended for domestic drinking water purification and typically mounted in use under a sink or a counter. The filter apparatus 10 includes a header 11 which controls the supply of water to and from the filter units each of which includes a housing 12 carrying a replaceable filter element 13. The housings 12 are adapted for threadable attachment to a corresponding threaded boss 14 depending downwardly from the underside of the header. The threaded open end 15 of each housing 12 may include a main O-ring seal 16 or other sealing arrangement to seal the threaded interface. In single filter systems, the header 11 is replaced with an enclosing end cap that includes water supply and discharge passages and a single threaded connection for the threaded open end of a single filter housing.

In the filter apparatus 10 shown in the drawings, three different filter elements 13 are interconnected through the header 11 to provide serial treatment of water supplied via a raw water inlet 17 at one end of the header. Raw unfiltered water is directed first to the housing 12 at the far end of the header to be treated by a cylindrical tubular pre-filter element 18 utilizing, for example, granular activated carbon as its filter media. Filtered water from the pre-filter element 18 re-enters the header 11 and is transferred to the intermediate housing 12 in which a reverse osmosis filter element 20 is housed. It should be understood that any of several other types of replaceable filter elements could be used in lieu of the RO filter element 20. Product water from the RO filter 20 is again returned to the header where, in the particular filter apparatus 10 shown, the water is directed through a storage tank outlet 21 in the header of the filter apparatus from which it passes into a pressurized storage tank (not shown). When a user opens a tap in a line connected to a filtered water outlet 22, in the header 11 between the raw water inlet 17 and the storage tank outlet 21, water passes from the storage tank in a reverse direction back into the header via the outlet 21 where it is directed into the third housing 12 containing a post-filter element 23, such as porous activated carbon block. The finally filtered water from the post-filter element 23 passes to the user tap (not shown) from the filtered water outlet 22 in the header.

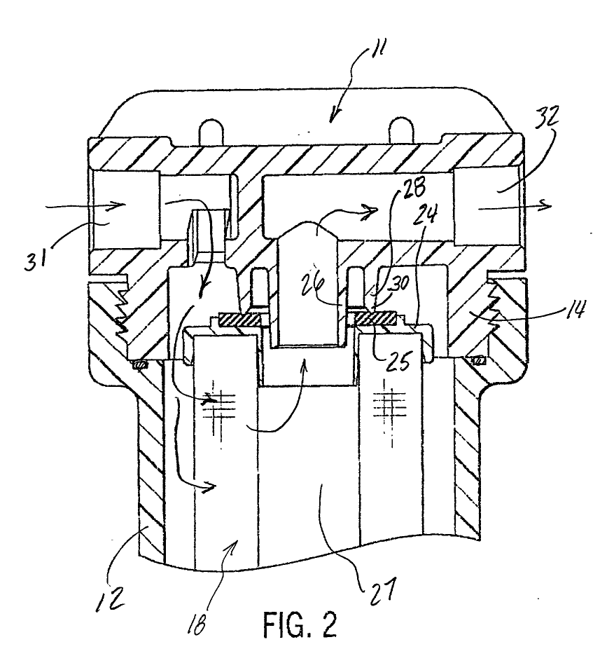

Each of the replaceable filter elements 18, 20 and 23, is similar in so far as each comprises a cylindrical tubular element having an axially extending open interior. Each of these filter elements includes a seal at its upper end which engages a portion of the header 11 inside the respective boss 14 to seal the axial open interior of the element from the outside of the element. The pre-filter element 18 and the post-filter element 23 have somewhat similar end seals and will be described with reference particularly to the pre-filter element 18 also shown in FIG. 2. The axial upper end of the pre-filter element 18 is closed by an annular end cap 24. The end cap 24 provides a seat for a ring-shaped seal element 25. The seal element 25 may be made of any suitable synthetic or natural rubber material of any of many kinds well known in the art. The ring-shaped seal element 25 typically has a generally rectangular cross section.

Centered in the boss 14 depending downwardly from the underside of the header 11 is a short tubular standpipe 26. When the housing 12 containing the pre-filter element 18 is threaded onto the boss 14, the standpipe 26 passes into the upper part of the open interior 27 of the filter element 18. Surrounding the standpipe 26 and coaxial therewith is a somewhat shorter cylindrical sleeve 28. The cylindrical sleeve 28 is tapered or beveled at its lower edge to define a blunt knife edge 30 that engages the annular seal element 25 on the upper end of the filter element 18 as the housing is threadably attached to the header. With the pre-filter element 18 in place and referring particularly to FIG. 2, water entering the filter inlet 31 in the header 11 passes downwardly into an annular space between the interior of the housing 12 and the outside of the pre-filter element 18 where it passes radially through the filter media, upwardly through the open interior 27 of the filter element, through the standpipe 26 and to a filter outlet 32 in the header from which it is directed within the header to the next filter element 20 contained in the center housing 12. The arrows in FIG. 2 show the path of flow into, through and out of the pre-filter element 18. It should be noted particularly that outlet flow through the standpipe 26 is completely unobstructed.

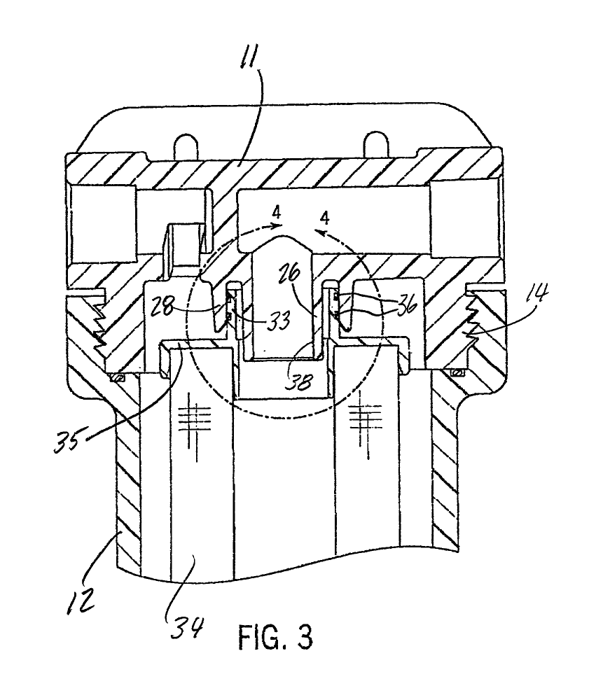

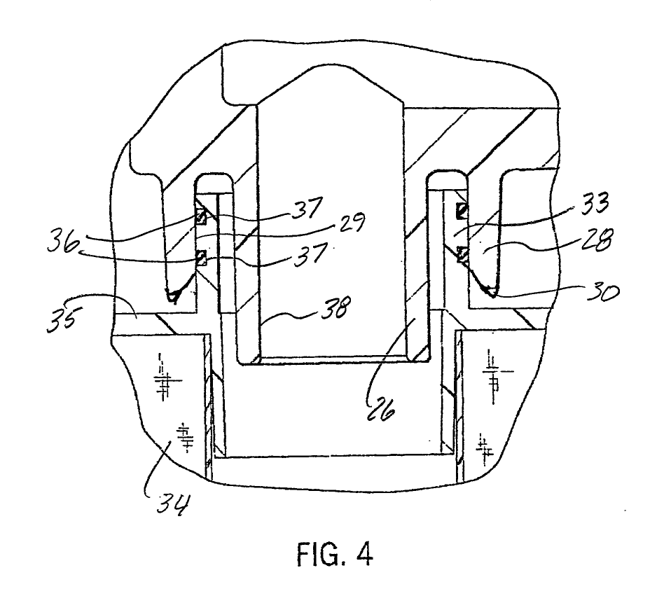

Referring also to FIGS. 3 and 4, the filter element 20 contained in the center housing 12 of the filter apparatus 10 is of the general type of element that includes a hollow cylindrical delivery tube 33 extending axially from the open upper end. Particularly in the construction of an RO filter element 20, the delivery tube 33 comprises an integral extension of a product water tube (not shown) that extends the full axial length of the hollow interior of the filter element. However, as shown in FIGS. 3 and 4, another tubular filter element 34 includes a delivery tube 33 on the outlet end of the filter element that is formed integrally with an annular end cap 35 that fits over the axial upper end of the filter element. A pair of axially spaced O-rings 36 are seated in annular grooves 37 in the outer surface of the delivery tube 33. The header boss 14 is of the same basic construction as the boss described for the pre-filter element 18 and includes a downwardly depending center standpipe 26 surrounded by a concentric cylindrical sleeve 28. Upon assembly of the filter element 34 in the housing 12 to the header, by attaching the threaded open end 15 of the housing to corresponding threaded boss, the delivery tube 33 enters the annular space between the standpipe 26 and the cylindrical sleeve 28 and the O-rings sealingly engage the cylindrical inner surface 29 of the sleeve 28. Thus, comparing the sealing interface in FIGS. 2 and 3, the cylindrical sleeve 28 provides direct sealing engagement with the respective seal elements 25 and 36. In other words, by providing bosses 14 with identical sealing sleeves 28, many of filter elements 18, 20 and 34 may be interchangeably utilized. In each instance, the central standpipe 26 remains unobstructed.

In many prior art replaceable filters having a delivery tube, similar to delivery tube 33, the delivery tube is of a smaller diameter and is adapted to be received within and to seal against the interior cylindrical surface 38 of the standpipe 26. The result is that cross sectional flow area of the standpipe is reduced with a resultant higher pressure drop through the filter in order to maintain the same flow. Thus, in accordance with the present invention, the outer concentric sealing sleeve 28 provides both multi-element adaptability and preserves unobstructed flow through the standpipe.

As may be best seen in FIG. 5, the post-filter element 23 includes an annular end seal element 40 that is similar in construction to the seal element 25 of the pre-filter element 18. The seal element 40 is mounted on the end of the filter element 23 and is adapted to be engaged by the blunt knife edge 30 of the cylindrical sleeve on the boss when the housing 12 is threaded onto the boss, as previously described with respect to the pre-filter element 18. The seal element 40 is preferably attached to an end cap 41, similar to end cap 24 of the pre-filter element 18, that encloses the end of the filter element 23.

Various alternatives and embodiments are contemplated as being within the scope of the following claims particularly pointing out and distinctly claiming the subject matter regarded as the invention.

I claim:

1. A filter apparatus providing adaptability to use either of a first cylindrical tubular filter element having an annular seal element surrounding one open end or a second cylindrical tubular filter element having a cylindrical delivery tube axially extending from one open end, said delivery tube carrying on an outer cylindrical surface thereof an O-ring seal arrangement, said apparatus comprising:
a housing having an open end for receipt of one of said filter elements inserted axially into said open end;
a header element providing a closure for the housing and the filter element and having a demountable connector for cooperative attachment to said housing; and,
a downwardly depending cylindrical sleeve on said header element generally axially aligned with the filter element and the housing, said sleeve having a free edge sealingly engaging the annular seal element of said first filter element in response to attachment of the header to the housing, and said sleeve having a cylindrical inner wall alternately receiving the delivery tube of said second filter element and sealingly engaging said O-ring seal arrangement in response to attachment of the header to the housing.

2. The apparatus as set forth in claim 1, wherein each of said filter elements includes an annular end cap on said one end.

3. The apparatus as set forth in claim 2, wherein the annular seal element of said first filter element comprises a ring-shaped seal of generally rectangular cross sections mounted on said end cap.

4. The apparatus as set forth in claim 2, wherein said delivery tube of said second filter element comprises an integral extension of said end cap.

5. The apparatus as set forth in claim 4, wherein said O-ring seal arrangement comprises a pair of axially spaced O-rings seated in annular grooves in the outer cylindrical surface of said delivery tube.

6. The apparatus as set forth in claim 1, wherein the delivery tube of said second filter element comprises an integral extension of a product water tube defining the tubular interior and extending substantially the full axial length of said filter element.

7. The apparatus as set forth in claim 6, wherein said O-ring seal arrangement comprises a pair of axially spaced O-rings seated in annular grooves in the outer cylindrical surface of said delivery tube.

8. The apparatus as set forth in claim 1, wherein the header element includes a tubular center standpipe inside and concentric with said cylindrical sleeve, said standpipe extending axially into the tubular interior of the filter element in response to connection of the header to the housing.

9. An enclosing end cap for a filter apparatus of the type utilizing a replaceable open-ended tubular filter element held in an enclosing housing having a threaded open end for demountable connection to a complimentary threaded boss on the end cap, said end cap providing a capability of sealing engagement with a filter element having one of an annular end seal surrounding the open end of the element and an O-ring seal mounted on an outside surface of a delivery tube extending axially from the open end of the element, said end cap comprising a cylindrical sleeve inside and concentric with the threaded boss, said sleeve having a free edge engageable with the annular end seal and an interior cylindrical surface engageable with the O-ring seal.

10. The apparatus as set forth in claim 9, comprising a cylindrical standpipe inside and concentric with said cylindrical sleeve, said standpipe sized to be received in the open end of the filter element in response to connection of the housing to the boss.
